(19) United States
(12) Patent Application Publication
(10) Pub. No.: US 2003/0213531 A1
(43) Pub. Date: Nov. 20, 2003

(54) Article scanning method and apparatus for computer-controlled sawing machines

(76) Inventor: Patrick M. Conry, Hot Springs, AR (US)

Correspondence Address: MANELLI DENISON & SELTER, 2000 M STREET NW SUITE 700, WASHINGTON, DC, 20036-3307, US

(21) Appl. No.: 10/146,804

(22) Filed: May 17, 2002

(51) Int. Cl. B27B 1/00; B23Q 15/00; B23Q 16/00; B26D 5/00

(52) U.S. Cl. 144/357; 83/368

(57) ABSTRACT

A prescan of log cant is performed and the data derived from the prescan is fed to a computer which analyzes the data to control positioning arms on a downstream positioning conveyor which feeds the cant to cutting scan station which provided data for controlling a movable gang saw. The positioning arms adjust the position of the cant to improve the operation of the gang saw and increase the useful output of the saw.

### FIELD OF THE INVENTION

The present invention relates to a method and apparatus for handling lumber in the form of boards or cants prior to supplying the lumber pieces to a gang saw of the type where the gang saw is mounted for pivoting movement as a lumber piece is moved past the gang saw.

### BACKGROUND OF THE INVENTION

In the operation of high speed lumber mills, it has been the practice to employ a movable gang saw to allow the gang saw to be moved as a piece of lumber is moved through the cutting position of the gang saw. To improve productivity and efficiency, each incoming log or cant is scanned optically and the results fed to a computer which controls the movement of the gang saw in correlation with conveying of the lumber in an effort to maximize production of useful boards. Such an arrangement is described in U.S. Pat. No. 5,722, 474, the disclosure of which is incorporated herein by reference.

It has become evident, however, that the use of a computer to control the position of the movable gang saw device requires control of the position of a board or cant in order to enable an operator to make full use of the advantages of the movable gang saw such as disclosed in the aforementioned patent in order to improve production capacity. Efficiency problems may arise due to a number of contingencies such as one or more defects in the board or cant that cannot be effectively compensated for, the positioning of the board on one or all of the conveyers particularly where the cant is of borderline quality, that is, one that exhibits extremes of curvature for which the gang saw cannot readily compensate at the throughput speeds in use in contemporary machines. The reasons for this inability to compensate for marginal cant shapes is likely due to some combination of these contingencies which presently used machinery is not adapted to handle at least without materially affecting throughput speeds. In many present day arrangements, the gang saw box must have sufficient time to adjust to handle the information obtained by the typical lineal scan of a cant. Since lineal scanning, that is, where the cant moves in a generally axial direction past scanning elements is common to these machines, providing a gap of a selected size between cants provides this time but as a user attempts to increase production throughput speeds, the necessity for greater sized gaps also increases.

As described in the above noted patent, It has been the practice to generate a computer solution from an optical scan to operate the movable gang saw to achieve the maximum production efficiency. The input to the computer is achieved by a lineal scan of an incoming cant or board primarily to derive an equation of its curvature versus length. It typically does not handle misplacement of a cant on the infeed conveyor. As a consequence, the spacing between cants and their orientation and position on the infeed and subsequent conveyors cannot be readily optimized. Typically, a cant is mechanically placed on the infeed conveyor with the spacing in between the cants chosen in such a way that the gang saw box can be moved as a result of an optical scan to assume the best position for the incoming cant and safe operating conditions will be assured and this usually results in a slower throughput speed.

### SUMMARY OF THE INVENTION

The present invention provides a method and apparatus for increasing production speeds while improving the recovery percentage for even marginal cants. In a preferred embodiment, the present invention provides a pre-scan of an incoming cant which is achieved by locating scanning equipment transversely of the cant adjacent the infeed conveyor before the usual lineal scan is accomplished. Thus, this invention is an improvement on the apparatus and method of U.S. Pat. No. 5,722, 474. The data collected by the scanning equipment is used to correctly position a cant on the infeed or positioning table conveyor just prior to the lineal scan which is used as described in the aforementioned U.S. patent to provide the best curve profile data for the gang saw operation. Preferably, the cant width, shape and thickness are determined and this data is fed to a computer which is programmed to calculate the time for effecting a cutting operation in the gang saw thus allowing use of a smaller gap spacing between cants. The apparatus will also allow more effective positioning of the cant relative to the capability of the gang saw to be pivoted relative to the path of travel of the cant through the gang saw and will also allow pre-positioning of the gang saw to minimize adjustment time as a new cant is fed toward the gang saw.

### BRIEF DESCRIPTION OF THE DRAWINGS

The foregoing and other advantages of the invention will become apparent as consideration is given to the following detailed description, in which:

FIG. 1 is an illustration of a cutting solution displayed on a cant;

FIG. 2A is a schematic, top plan view of an infeed conveyor, scanning position and positioning table; and

FIG. 2B is a schematic top plan illustration of a second scanning position and pivoting gang saw device used in the present invention.

### DETAILED DESCRIPTION OF THE INVENTION

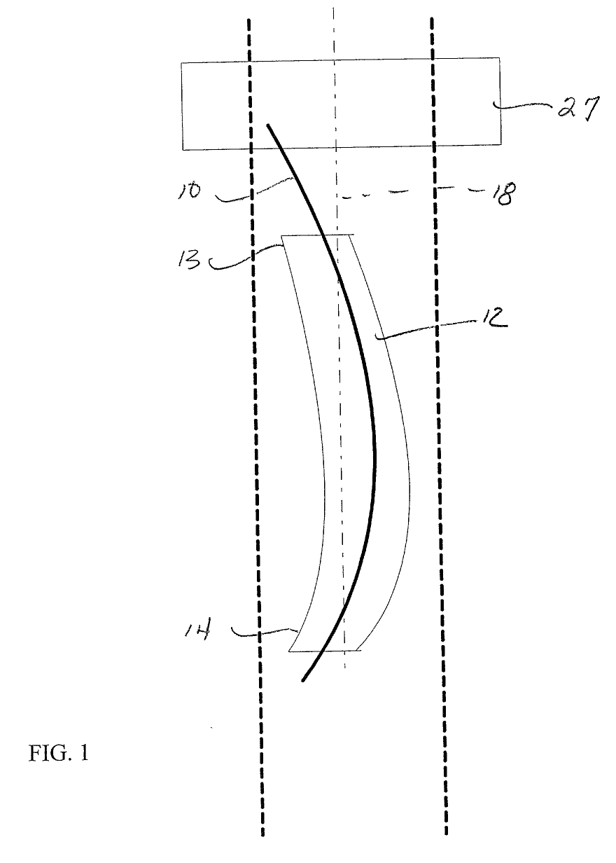

Referring to the drawings, there is shown in FIG. 1, a cutting solution line 10 displayed extending across a cant 12 where the cant exhibits a curvature along its length that must be accommodated by the gang saw 16 movements to maximize the useful output of lumber. The leading end 13 of the cant 12 may be held by press rolls (not shown) to assure proper feeding of the end 13 into the saw box 16. It happens that the curvature of some cants is so severe that such a cant cannot be efficiently handled by the gang saw box schematically indicated at 16 since the movement of the cant 12 will be along the center line 18 into the saw box 16. It will be evident that the number of cut boards of the maximum length due to a curvature of the cant and position of the cant 12 on an infeed conveyor will not be achievable at the usual production speed. With saw equipment such as disclosed in U.S. Pat. No. 5,722, 474 in use, the cutting solution represented by the line 10 can be calculated on the basis of a lineal scan of the cant 12 which will attempt to take into account the one or more curvatures of the cant. The solution path 10 is shown and the object of this invention is to locate or position that path 10 on the positioning table conveyor 21 to cut the maximum boards of the same thickness even in the vicinity of the end 14. Once positioned, the cant 12 is then passed to the saw box or gang 16 which will be mechanically moved under the control of the position algorithm which takes into account the possible angles of movement of the saw box 16, the curvature of the cant and the length of the cant 12.

According to the present invention, the cant 12 will be moved from the infeed conveyor 20 past a scanning equipment such as, for example, a set of photocells 26 which perform an additional scan of the cant 12 before the lineal scan takes place at 27. As will be apparent to those skilled in this field, any number of commercially available types of scanning devices can be used. The data derived from the photocells 26 scan will be supplied to a computer (not shown) which will calculate the width, length, shape and position of the cant in plan view. The cant is then passed by a suitable transfer conveyor to the pre-positioning table 23 along which positioning devices such as hydraulic or pneumatic arms 30 controlled by the computer connected to the photocells 26 will mechanically position the cant 12 on the table 22 relative to the center line of the downstream gang saw 18 in the saw box 16. Thus, the ideal positioning of the cant 12 can be achieved in advance of the lineal scan and well in advance of the entry of the cant 12 into the saw box 16. As a result of this positioning, the solution path will more nearly approximate the centerline of the cant 12 taking into account any curvatures along the length of the cant 12. This will result in improved efficiency in sawing the cant 12. This can be achieved, for example, by positioning of the cant 12 relative to the maximum cutting angle of the saw box 16 for a severely curved cant member. It will be evident that for a given machinery set up, improved recovery of lumber from even defective cants will be achieved.

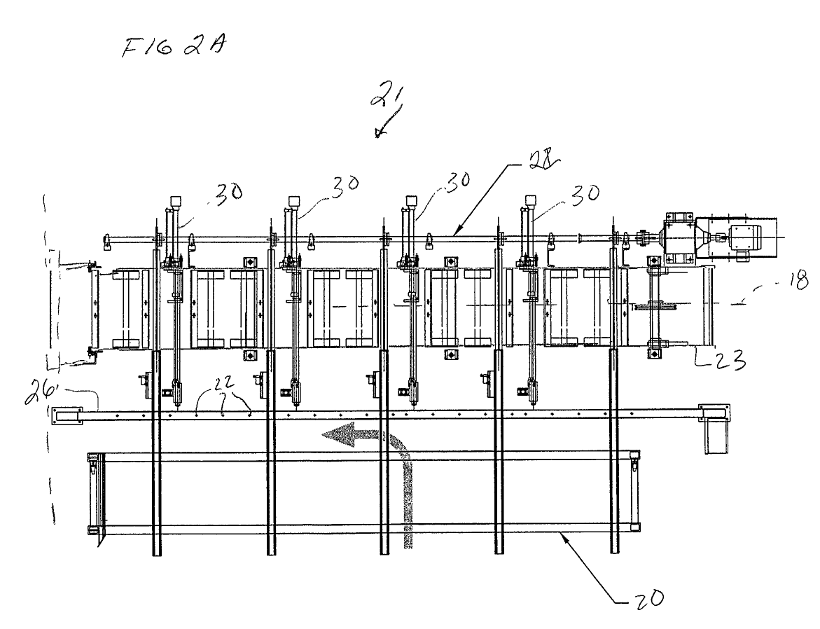

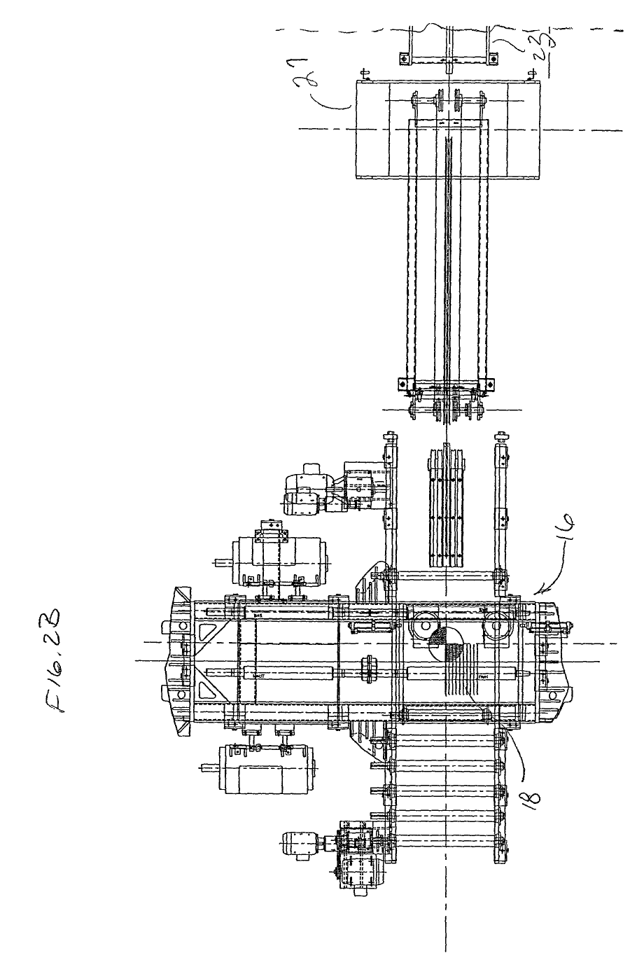

Positioning algorithms are used in conjunction with a computer to analyze data from the set of scanning equipment such as the photocells as shown in FIG. 2A at 22 extending horizontally above the in feed conveyor 20 on which is carried the cants 12. The photocells 22 are mounted in a suitable bracket 26 which may surround the conveyor 20 in order to provide readings useful in determining the width, curvature and length of the cant 12 carried on the conveyor 20 as well as its position relative to an arbitrary set point. As will be apparent to those skilled in this technology, the photocells 22 can be aligned with a respective illumination source located on the opposite side of the bracket 26. Once a log or cant has passed through the bracket 26, the dimensional and position data derived from the scanning is passed to a computer (not shown) which will be used to activate positioning arms 30 which may be hydraulically or pneumatically controlled to position the cant 12 relative to the set point such as the centerline 18 of the conveyor system 23 and in a preferred position relative to the gang saw 16. As is described in the aforementioned U.S. patent, the gang saw 16 is movable relative to the centerline 18 to follow the curve solution derived from a lineal scan of the cant 12 as described in this patent. The photocells in the bracket 26 improve on this process enabling positioning of the cant 12 relative to a preferred cutting solution which also takes into account the possible angles of pivoting of the gang saw 16 relative to the infeed angle of the cant 12 as well as the outfeed angles possible. Further, the adjustment of the saw box 16 relative to the leading edge 13 of the incoming cant 12 can be accomplished automatically and immediately after one cant 12 has been finished. This will allow a reduced gap and consequent delay in initiating a subsequent cutting operation on the next cant 12. This will assure the maximum production of useful wood material without adversely affecting the production speed of the gang saw.

Having described the invention, it will be apparent to those skilled in this technology that various modifications may be made thereto without departing from the spirit and scope of the invention.

What is claimed is:

1. A cant positioning apparatus for an infeed conveyor of a gang saw device where the gang saw device includes a cutting bank of saws movable through a predetermined pivot angle, a cant first scanning array located upstream relative to the direction of movement of the cant of the gang saw device and said infeed conveyor, a positioning conveyor located upstream of said infeed conveyor and downstream of said first scanning array, said positioning conveyor including a plurality of cant positioning members spaced along a length of said positioning conveyor, computer means for receiving and analyzing the results of output of said first scanning array and for actuating at least some of said cant positioning members to position a cant on said positioning conveyor relative to the path of travel of the cant so that the cant will be cut to produce the maximum of usable lumber from the cant with said gang saw operating within said predetermined pivot angle.

2. The invention as claimed in claim 1 wherein said first scanning array includes a plurality of photocells and illumination means with each said photocell positioned to cooperate with a said illumination means.

3. The invention as claimed in claim 2 wherein said illumination means are light sources.

4. The invention as claimed in claim 1 wherein said cant positioning members include fluid actuated cylinders the actuation of which is controlled by said computer.

5. The invention as claimed in claim 4 wherein said cylinders are spaced apart along said positioning conveyor.

6. The invention as claimed in claim 1 wherein a second scanning array is provided and located downstream of said positioning conveyor and upstream of said gang saw.

7. The invention as claimed in claim 1 wherein said first scanning array includes a bracket through which the cant is moved to said positioning conveyor.

8. A method of handling a cant prior to introduction of the cant to a movable gang saw comprising the steps of passing the cant through a scanning array; passing the data derived from the scanning array to a computer which controls positioning arms on a positioning conveyor, transferring the cant to the positioning conveyor and modifying the position of the cant on the positioning conveyor relative to the gang saw to improve the efficiency of the operation of the gang saw on the cant.
